(19) United States
(12) Patent Application Publication
(10) Pub. No.: US 2026/0307604 A1
(43) Pub. Date: Oct. 8, 2026

(54) PROTECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Yukinori KITA, Osaka (JP); Hiroshi SUDO, Osaka (JP); Takamune KIKUTA, Osaka (JP); Ayana FUJITAKA, Osaka (JP)

(21) Appl. No.: 19/482,780

(22) PCT Filed: May 2, 2024
(86) PCT No.: PCT/JP2024/016876

§ 371 Date: Nov. 10, 2025

(30) Foreign Application Priority Data
May 11, 2023 (JP) 2023-078788

(51) Int. Cl. B60R 16/02; H02G 3/04

(52) U.S. Cl. CPC B60R 16/0215; H02G 3/04

(57) ABSTRACT

A protector includes an inner case that has an opening portion and houses a wire harness, and an outer case that covers the opening portion of the inner case. The outer case includes a cover portion that covers a side of the inner case opposite to an installation surface, and a pair of outer wall portions that extend from the cover portion and face each other. The inner case is mounted between the pair of outer wall portions. The pair of outer wall portions respectively have abutment portions capable of abutting against the installation surface in a state where the protector is disposed on the installation surface.

### TECHNICAL FIELD

The present disclosure relates to a protector.

### BACKGROUND

When electrical devices are mounted to a conventional vehicle, a wire harness for connecting the electrical devices to each other may be disposed within an occupant compartment of the vehicle (see, for example, Patent Document 1). In this case, the wire harness is usually disposed at a location where it is not exposed, such as inside an interior member that constitutes the occupant compartment.

### PRIOR ART DOCUMENT

### Patent Document

Patent Document 1: JP 2014-151778 A

### SUMMARY OF THE INVENTION

### Problems to be Solved

As described above, when disposing the wire harness inside the interior member, it is necessary to detach and attach the interior member, and thus there has been a problem in that the operation of disposing the wire harness is complicated. In view of this, it is conceivable that, in order to easily dispose the wire harness within the occupant compartment, the wire harness is disposed in a state where it is exposed within the occupant compartment. In that case, there is a need to consider how to protect the wire harness.

An object of the present disclosure is to provide a protector that can protect a wire harness that is disposed within an occupant compartment.

### Means to Solve the Problem

The protector of the present disclosure is a protector that is configured to house a wire harness and is to be disposed on an installation surface in an occupant compartment of a vehicle, including: an inner case that has an opening portion and is configured to house the wire harness; and an outer case configured to cover the opening portion of the inner case, wherein the outer case includes a cover portion configured to cover a side of the inner case opposite to the installation surface, and a pair of outer wall portions that extend from the cover portion and face each other, the inner case is configured to be mounted between the pair of outer wall portions, and the pair of outer wall portions respectively have abutment portions capable of abutting against the installation surface in a state where the protector is disposed on the installation surface.

### Effect of the Invention

With a protector according to the present disclosure, it is possible to protect a wire harness that is disposed within an occupant compartment.

### BRIEF DESCRIPTION OF THE DRAWINGS

FIG. 1 is a schematic diagram of a vehicle equipped with a protector according to an embodiment of the present disclosure.

FIG. 2 is a perspective view of the protector according to the embodiment.

FIG. 3 is a cross-sectional view of the protector according to the embodiment.

FIG. 4 is a cross-sectional view of a protector according to a modified example.

### DETAILED DESCRIPTION TO EXECUTE THE INVENTION

### Description of Embodiments of the Present Disclosure

First, embodiments of the present disclosure will be listed and described.

[1] A protector according to the present disclosure is a protector that is configured to house a wire harness and is to be disposed on an installation surface in an occupant compartment of a vehicle, including: an inner case that has an opening portion and is configured to house the wire harness; and an outer case configured to cover the opening portion of the inner case, wherein the outer case includes a cover portion configured to cover a side of the inner case opposite to the installation surface, and a pair of outer wall portions that extend from the cover portion and face each other, the inner case is configured to be mounted between the pair of outer wall portions, and the pair of outer wall portions respectively have abutment portions capable of abutting against the installation surface in a state where the protector is disposed on the installation surface.

With this configuration, it is possible to protect the wire harness disposed on the installation surface in the occupant compartment using the protector. In addition, by the abutment portions of the respective outer wall portions of the protector abutting against the installation surface, even when the protector is stepped on from above, the force is made less likely to be applied to the inner case disposed between the pair of outer wall portions. For this reason, it is possible to more suitably protect the inner case and the wire harness housed in the inner case.

[2] In above [1], the inner case may include a bottom wall and a pair of side walls that extend from the bottom wall and face each other in a width direction of the protector, the bottom wall and the pair of side walls may cooperate to form a groove portion for housing the wire harness, and the opening portion may be formed by leading end portions of the pair of side walls on an opposite side to the bottom wall.

With this configuration, the bottom wall and the pair of side walls can form the groove portion of the inner case for housing the wire harness.

[3] In above [2], the cover portion may cover the opening portion, and, in a state where the inner case is mounted between the pair of outer wall portions, the pair of outer wall portions may be positioned outside the pair of side walls along the width direction.

With this configuration, the rigidity of the protector can be suitably improved by the outer wall portions of the outer case covering the side walls of the inner case.

[4] In above [3], the inner case may have an extending wall that extends from the bottom wall between the pair of side walls, and whose leading end portion in an extending direction is capable of coming into contact with the cover portion.

With this configuration, the rigidity of the inner case can be improved using the extending wall. In addition, for example, when the cover portion of the outer case bends toward the groove portion of the inner case due to an external force, the external force can be received by the extending wall.

[5] In above [3] or [4], the cover portion may have a reinforcing rib that protrudes toward the groove portion, and the reinforcing rib may be configured to be disposed between a plurality of electric wires contained in the wire harness housed in the groove portion.

With this configuration, the reinforcing rib can suppress deformation such as warping of the cover portion during molding of the outer case. In addition, since the reinforcing rib is configured to be disposed between the plurality of electric wires housed in the groove portion, it is possible to keep the reinforcing rib from interfering with the electric wires.

[6] In any of above [2] to [5], a depth of the groove portion may be greater than an outer diameter of an electric wire of the wire harness.

With this configuration, a clearance can be set between each inner surface of the protector and the electric wires. Accordingly, it is possible to keep the electric wires from being pinched between the inner case and the outer case.

[7] In any one of above [1] to [6], the pair of outer wall portions may respectively have supporting portions configured to support the inner case.

With this configuration, the supporting portions of the respective outer wall portions can keep the inner case from coming off from between the pair of outer wall portions.

### Detailed Embodiments of Present Disclosure

Specific examples of a protector according to the present disclosure will be described below with reference to the drawings. In the drawings, parts of the configurations may be shown in an exaggerated or simplified manner for convenience of description. In addition, dimensional ratios of portions may be different between figures. Note that “tubular” as used in the present specification is not limited to a structure in which a peripheral wall is continuously formed over the entire circumference, but also encompasses a structure in which a plurality of parts are combined to form a tubular shape, or a structure partially having a cutout or the like in the circumferential direction to form, for example, a C-shape. In addition, a “tubular” shape also includes circular shapes, elliptical shapes, and polygonal shapes having sharp or rounded corners.

“Facing” in the present specification refers to surfaces or members being positioned in front of each other, and includes not only cases where they are positioned precisely in front of each other but also cases where they are partially positioned in front of each other. “Facing” in the present specification also includes both cases where two portions are disposed with a member other than the two portions interposed therebetween and cases where nothing is interposed between two portions.

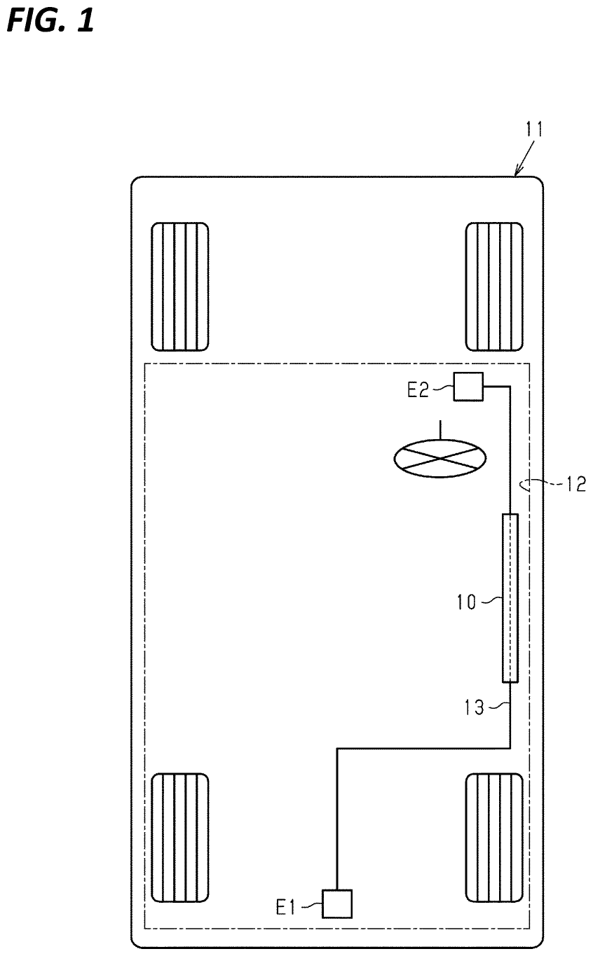

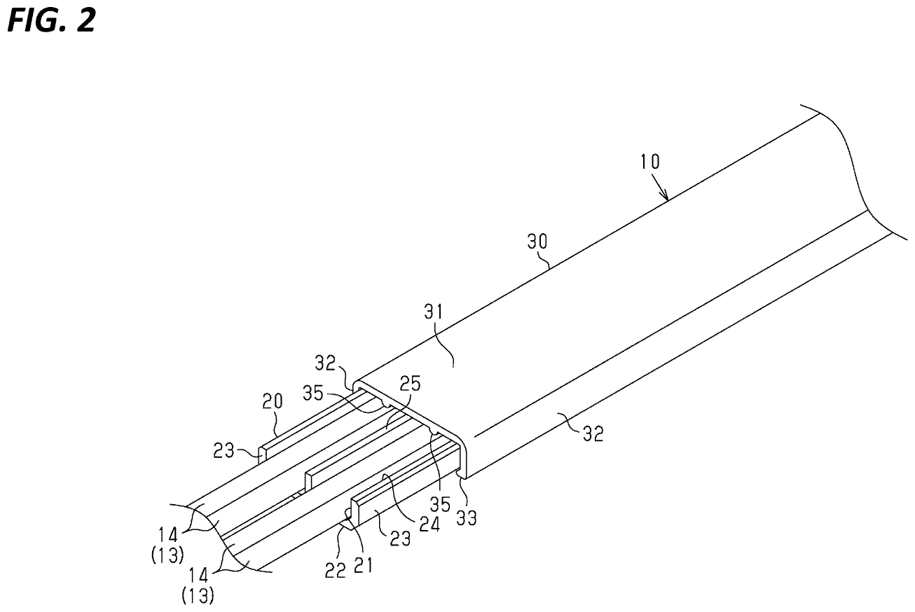

As shown in FIG. 1, a protector 10 according to the present embodiment is mounted to a wire harness 13 that is disposed within an occupant compartment 12 of a vehicle 11. The wire harness 13 includes, for example, a plurality of electric wires 14 (see FIG. 2). In the present embodiment, the wire harness 13 includes four electric wires 14. The wire harness 13 electrically connects a first electrical device E1 and a second electrical device E2, both of which are mounted to the vehicle 11.

Examples of the first electrical device E1 include a sensor apparatus such as an image capture apparatus. The first electrical device E1 is provided, for example, at a position on the rear side of the occupant compartment 12 of the vehicle 11, such as a back door of the vehicle 11.

Examples of the second electrical device E2 include an electronic control unit (ECU) and the like. The second electrical device E2 is provided, for example, at a position in the vicinity of the front of the occupant compartment 12, inside or outside the occupant compartment 12. Note that the occupant compartment 12 is a compartment of the vehicle 11 that is occupied by occupants including the driver. For example, the occupant compartment 12 may be configured to accommodate or support seats for the occupants.

The wire harness 13 that connects the first electrical device E1 and the second electrical device E2 is routed within the occupant compartment 12. The protector 10 protects the wire harness 13 routed in the occupant compartment 12 by covering a predetermined area in the lengthwise direction of the wire harness 13.

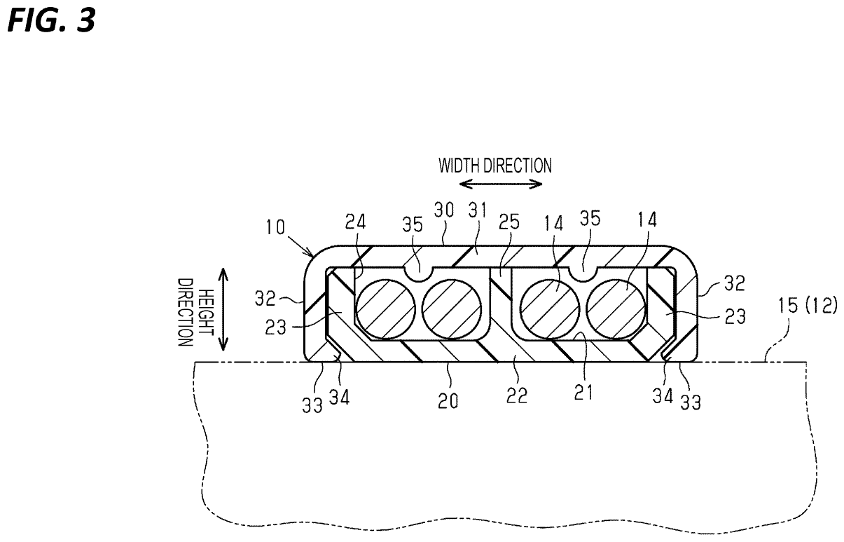

As shown in FIG. 3, the protector 10 housing the wire harness 13 is disposed on an installation surface 15 in the occupant compartment 12. The installation surface 15 is, for example, a floor surface of the occupant compartment 12, and the protector 10 is placed on the floor surface.

### (Configuration of Protector 10)

As shown in FIGS. 2 and 3, the protector 10 includes an inner case 20 and an outer case 30. The inner case 20 and the outer case 30 are separate from each other. The inner case 20 and the outer case 30 are each formed, for example, of a synthetic resin. The protector 10 is formed in a tubular shape capable of housing the wire harness 13 by combining the inner case 20 and the outer case 30. Therefore, the inner case 20 and the outer case 30 can cover the entire outer periphery of the wire harness 13.

### (Configuration of Inner Case 20)

The inner case 20 has an elongated shape along the lengthwise direction of the wire harness 13. The inner case 20 has a groove portion 21 capable of housing the wire harness 13 containing the electric wires 14. The groove portion 21 extends along the lengthwise direction of the wire harness 13. The groove portion 21 is formed by a bottom wall 22 and a pair of side walls 23 of the inner case 20.

The pair of side walls 23 extend from the bottom wall 22 in such a manner as to face each other in the width direction of the protector 10. The bottom wall 22 and the pair of side walls 23 are provided, for example, over the entire inner case 20 in the lengthwise direction. The inner case 20 that includes the bottom wall 22 and the pair of side walls 23 is formed to have a substantially U-shaped transverse cross-section. In addition, the transverse cross-sectional shape of the inner case 20 is, for example, uniform over the entire inner case 20 in the lengthwise direction.

The groove portion 21 of the inner case 20 has an opening portion 24 formed by the leading end portions of the pair of side walls 23 on the opposite side to the bottom wall 22. The opening portion 24 is, for example, open upward in the height direction of the protector 10. The electric wires 14 are housed in the groove portion 21 through the opening portion 24, for example. Note that, for example, the protector 10 is disposed on the installation surface 15 such that the height direction of the protector 10 is approximately vertical with respect to the installation surface 15.

The electric wires 14 of the wire harness 13 are disposed in the groove portion 21 of the inner case 20. The plurality of electric wires 14 are, for example, arranged in the groove portion 21 in such a manner as to be aligned along the width direction of the protector 10. The wire harness 13 containing the electric wires 14 is drawn out of the protector 10 from one of the two ends of the groove portion 21 in the lengthwise direction of the protector 10. The depth of the groove portion 21 is set to be greater than the outer diameter of the electric wires 14 of the wire harness 13. That is, a clearance is set between the inner surface of the protector 10 and the electric wires 14. Note that the depth of the groove portion 21 is the dimension of the groove portion 21 in a direction along the opening direction of the opening portion 24. That is, in the present embodiment, the depth of the groove portion 21 is the dimension of the groove portion 21 in the height direction of the protector 10.

The inner case 20 has an extending wall 25 that extends from the bottom wall 22 between the pair of side walls 23. The extending wall 25 is, for example, linear along the lengthwise direction of the inner case 20. The extending wall 25 faces the side walls 23 in the width direction of the protector 10. The extending wall 25 is, for example, provided at a central portion of the bottom wall 22 in the width direction of the protector 10. By forming the extending wall 25 on the bottom wall 22, the rigidity of the bottom wall 22 is improved.

### (Configuration of Outer Case 30)

The outer case 30 is configured to cover the opening portion 24 of the groove portion 21 of the inner case 20. The outer case 30 includes a cover portion 31 and a pair of outer wall portions 32 extending from the cover portion 31. The outer case 30 that includes the cover portion 31 and the pair of outer wall portions 32 is formed to have a substantially U-shaped transverse cross-section.

The cover portion 31 covers the inner case 20 on the opposite side to the installation surface 15. In the present embodiment, the cover portion 31 covers an upper side of the inner case 20 in the height direction of the protector 10. In addition, in the present embodiment, the cover portion 31 covers, for example, the opening portion 24 of the inner case 20.

The extending wall 25 of the inner case 20 is configured such that the leading end portion thereof in the extending direction is capable of coming into contact with the cover portion 31. Note that the leading end portion of the extending wall 25 may be in contact with the cover portion 31 in a state where no external force is applied to the cover portion 31. Alternatively, a clearance may be set between the leading end portion of the extending wall 25 and the cover portion 31 in a state where no external force is being applied to the cover portion 31. In this case, it is sufficient that the cover portion 31 can come into contact with the leading end portion of the extending wall 25 when the cover portion 31 is bent toward the groove portion 21 of the inner case 20 due to an external force or the like.

The extending wall 25 in the present embodiment partitions the housing space in the groove portion 21 into multiple sections. The number of extending walls 25 in the present embodiment is one, for example. Therefore, the extending wall 25 partitions the housing space in the groove portion 21 into two, for example. The plurality of electric wires 14 of the wire harness 10 are divided into two groups of electric wires, which are respectively housed in two housing spaces obtained by dividing the housing space by the extending wall 25 in the groove portion 21. In the present embodiment, for example, two electric wires 14 are housed in each of the two housing spaces.

### (Configuration of Pair of Outer Wall Portions 32)

The outer wall portions 32 extend, for example, from the two end portions in the width direction of the cover portion 31. The outer wall portions 32 extend, for example, along the height direction of the protector 10. The pair of outer wall portions 32 face each other in the width direction of the protector 10. The inner case 20 is mounted between the pair of outer wall portions 32. The pair of outer wall portions 32 of the outer case 30 are positioned outside the pair of side walls 23 in the width direction of the protector 10.

The pair of outer wall portions 32 respectively have abutment portions 33. The abutment portions 33 are set at the lower end portions of the respective outer wall portion 32. The abutment portions 33 abut against the installation surface 15 in a state where the protector 10 is placed on the installation surface 15. That is, in the present embodiment, the height dimension of the outer wall portions 32 is set to be greater than or equal to the height dimension of the inner case 20. Note that the height dimension of the outer wall portions 32 is the distance from the lower surface of the cover portion 31 to the upper ends of the outer wall portions 32 in the height direction of the protector 10. The height dimension of the inner case 20 is the distance from the lower surface of the bottom wall 22 to the upper ends of the side walls 23 in the height direction of the protector 10.

The pair of outer wall portions 32 respectively have supporting portions 34 that support the inner case 20. The supporting portions 34 protrude inward in the width direction from the lower end portions of the outer wall portions 32, for example. The supporting portions 34 have an elongated shape along the lengthwise direction of the protector 10. Accordingly, the outer wall portions 32 having the supporting portions 34 have a rail-like structure along the lengthwise direction of the protector 10. Note that the supporting portions 34 may be provided over the entire protector 10 in the lengthwise direction or may be provided partially along the lengthwise direction of the protector 10.

The inner case 20 can be attached between the pair of outer wall portions 32 of the outer case 30 along the lengthwise direction of the protector 10. When attaching the inner case 20 to the outer case 30 along the lengthwise direction, the inner case 20 is guided by the pair of outer wall portions 32 having a rail-like structure.

The supporting portions 34 are configured to catch on the respective side walls 23 of the inner case 20 in the height direction of the protector 10. For example, the supporting portions 34 are designed to catch on the lower end portions of the side walls 23. Accordingly, the inner case 20 is kept from falling downward in the height direction from between the pair of outer wall portions 32.

The cover portion 31 of the outer case 30 has a reinforcing rib 35 that protrudes toward the groove portion 21. The reinforcing rib 35 protrudes from the cover portion 31 toward the groove portion 21. The reinforcing rib 35 has an elongated shape extending along the lengthwise direction of the protector 10, for example. The reinforcing rib 35 also has a linear shape along the lengthwise direction of the protector 10, for example.

A plurality of reinforcing ribs 35 are provided, for example. The reinforcing ribs 35 are provided in correspondence with the respective housing spaces in the groove portion 21 partitioned by the extending wall 25, for example. That is, in the present embodiment, two reinforcing ribs 35 are provided. The reinforcing ribs 35 are configured to be disposed between the plurality of electric wires 14 housed in the groove portion 21.

Effects of the present embodiment will be described.

(1) The protector 10 can protect the wire harness 13 that is disposed on the installation surface 15 in the occupant compartment 12. In addition, in the protector 10, the pair of outer wall portions 32 of the outer case 30 have the abutment portions 33 that can abut against the installation surface 15 in a state where the protector 10 is disposed on the installation surface 15. Therefore, by the abutment portions 33 of the respective outer wall portions 32 of the protector 10 abutting against the installation surface 15, even when the protector 10 is stepped on from above, the force is made less likely to be applied to the inner case 20 disposed between the pair of outer wall portions 32. For this reason, it is possible to more suitably protect the inner case 20 and the wire harness 13 housed in the inner case 20. In addition, as described above, since a force is unlikely to be applied to the inner case 20, the degree of freedom in selecting a material for forming the inner case 20 is increased, enabling a low-cost material having low rigidity to be selected, for example.

(2) The inner case 20 has the bottom wall 22 and the pair of side walls 23 that extend from the bottom wall 22 and face each other in the width direction of the protector 10. The bottom wall 22 and the pair of side walls 23 cooperate to form the groove portion 21 that houses the wire harness 13. The opening portion 24 is formed by the leading end portions of the pair of side walls 23 on the opposite side to the bottom wall 22. With this configuration, the bottom wall 22 and the pair of side walls 23 can form the groove portion 21 of the inner case 20 for housing the wire harness 13.

(3) The cover portion 31 covers the opening portion 24 of the groove portion 21 of the inner case 20. In a state where the inner case 20 is mounted between the pair of outer wall portions 32, the pair of outer wall portions 32 are respectively positioned outside the pair of side walls 23 in the width direction. With this configuration, the side walls 23 of the inner case 20 are respectively covered by the outer wall portions 32 of the outer case 30, and thus the rigidity of the protector 10 can be suitably improved.

(4) The inner case 20 has the extending wall 25 that extends from the bottom wall 22 between the pair of side walls 23. The extending wall 25 is configured such that the leading end portion in the extending direction can come into contact with the cover portion 31. With this configuration, the rigidity of the inner case 20 can be improved using the extending wall 25. In addition, for example, when the cover portion 31 of the outer case 30 bends toward the groove portion 21 of the inner case 20 due to an external force, the external force can be received by the extending wall 25.

(5) The cover portion 31 has the reinforcing ribs 35 that protrude toward the groove portion 21. The reinforcing ribs 35 are configured to be disposed between the plurality of electric wires 14 contained in the wire harness 13 housed in the groove portion 21. With this configuration, the reinforcing ribs 35 can suppress deformation such as warping of the cover portion 31 during molding of the outer case 30. In addition, since the reinforcing ribs 35 are configured to be disposed between the plurality of electric wires 14 housed in the groove portion 21, it is possible to keep the reinforcing ribs 35 from interfering with the electric wires 14.

(6) The depth of the groove portion 21 may be set to be greater than the outer diameter of the electric wires 14 of the wire harness 13. With this configuration, a clearance can be set between each inner surface of the protector 10 and the electric wires 14. Accordingly, it is possible to keep the electric wires 14 from being pinched between the inner case 20 and the outer case 30.

(7) The pair of outer wall portions 32 have the supporting portions 34 that support the inner case 20. With this configuration, the supporting portions 34 of the respective outer wall portions 32 can keep the inner case 20 from coming off from between the pair of outer wall portions 32.

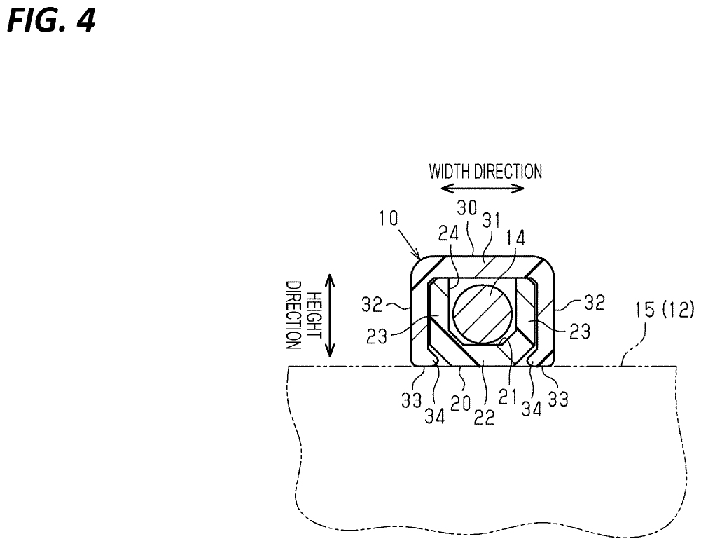

The above embodiments can be modified and implemented as follows. The above embodiments and the modified example below can be combined unless they are technically inconsistent.
The protector 10 according to the above embodiment is configured to house a plurality of electric wires 14, but the invention is not limited to this configuration, and, for example, as shown in FIG. 4, the protector 10 may be configured to house only one electric wire 14. Note that, in FIG. 4, the same reference numerals are given to constituent elements identical or corresponding to those in the above embodiment. Note that, in the example shown in FIG. 4, the extending wall 25 in the inner case 20 is omitted, and the reinforcing ribs 35 in the outer case 30 are also omitted.
In the above embodiment, the outer case 30 has been described as having a U-shaped transverse cross-sectional shape, but there is no limitation thereto, and the outer case 30 may be changed to another shape. Note that, even when the outer case 30 is changed to another shape, it is necessary to provide the outer case 30 with the pair of outer wall portions 32 respectively having the abutment portions 33 that abut against the installation surface 15.
In the above embodiment, the inner case 20 has been described as having a U-shaped transverse cross-sectional shape, but there is no limitation thereto, and the inner case 20 may be changed to another shape.
In the above embodiment, the opening portion 24 of the inner case 20 has been described as being open upward in the height direction of the protector 10, but there is no limitation thereto, and, for example, the opening portion 24 may be provided to be open in another direction such as the width direction of the protector 10. Note that, in a configuration where the opening portion 24 is open in the width direction of the protector 10, the opening portion 24 is covered by an outer wall portion 32. In addition, in a configuration where the opening portion 24 is open in the width direction of the protector 10, the cover portion 31 of the outer case 30 is configured to cover the upper side of a side wall 23 of the inner case 20 that extend along the width direction of the protector 10.
The extending wall 25 of the inner case 20 according to the above embodiment may be omitted.
The reinforcing ribs 35 of the outer case 30 according to the above embodiment may be omitted.
The protector 10 according to the above embodiment may be configured such that at least a portion in the lengthwise direction of the inner case 20 is spaced from the installation surface 15 in a state where the protector 10 is disposed on the installation surface 15.
In the protector 10 according to the above embodiment, at least one of the inner case 20 and the outer case 30 may have a fixing portion that is fixed to the installation surface 15.
The material for forming the inner case 20 and the outer case 30 is not limited to a synthetic resin, and may be changed to a metal material, for example.
The number of the electric wires 14 included in the wire harness 13 is not limited to the above embodiments, and may be three or less, or five or more.
The installation surface 15 on which the protector 10 is disposed is not limited to the floor surface of the occupant compartment 12 and may be a side wall or a ceiling member of the occupant compartment 12, for example.
As in the non-limiting examples shown in FIGS. 3 and 4, both the inner case 20 and the outer case 30 of the protector 10 may each be formed as a one-piece synthetic resin component. The inner case 20 may be referred to as an electric wire receiving tray.
As in the non-limiting examples shown in FIGS. 3 and 4, the inner case 20 may include the bottom wall 22 having a length and a width, and the side walls 23 each having a length and a height. The side walls 23 may have base end portions and leading end portions that define the height of the side walls 23, the base end portions being continuous with the bottom wall 22 and the leading end portions being located on the opposite side to the bottom wall 22. The base end portions of the side walls 23 may include bent portions. The bent portions of the side walls 23 may each be referred to as a key groove that is engaged with the corresponding supporting portion 34 of the outer case 30, and the supporting portion 34 of the outer case 30 may be referred to as a key. The engagement between the key groove and the key is advantageous in reducing play between the inner case 20 and the outer case 30.
The embodiments and modified examples disclosed herein are examples in all respect, and the present invention is not limited to illustrations of these. That is, the scope of the present invention is indicated by the claims, and is intended to include all modifications that are within the meanings and the scope that are equivalent to those of the claims.

### LIST OF REFERENCE NUMERALS

10 Protector
11 Vehicle
12 Occupant compartment
13 Wire harness
14 Electric wire
15 Installation surface
20 Inner case
21 Groove portion
22 Bottom wall
23 Side wall
24 Opening portion
25 Extending wall
30 Outer case
31 Cover portion
32 Outer wall portion
33 Abutment portion
34 Supporting portion
35 Reinforcing rib
E1 First electrical device
E2 Second electrical device

1. A protector that is configured to house a wire harness and is to be disposed on an installation surface in an occupant compartment of a vehicle, comprising:
an inner case that has an opening portion and is configured to house the wire harness; and
an outer case configured to cover the opening portion of the inner case,
wherein the outer case includes a cover portion configured to cover a side of the inner case opposite to the installation surface, and a pair of outer wall portions that extend from the cover portion and face each other,
the inner case is configured to be mounted between the pair of outer wall portions, and
the pair of outer wall portions respectively have abutment portions capable of abutting against the installation surface in a state where the protector is disposed on the installation surface.

2. The protector according to claim 1,
wherein the inner case includes a bottom wall and a pair of side walls that extend from the bottom wall and face each other in a width direction of the protector,
the bottom wall and the pair of side walls cooperate to form a groove portion for housing the wire harness, and
the opening portion is formed by leading end portions of the pair of side walls on an opposite side to the bottom wall.

313. The protector according to claim 2,
wherein the cover portion covers the opening portion, and
in a state where the inner case is mounted between the pair of outer wall portions, the pair of outer wall portions are positioned outside the pair of side walls along the width direction.

4. The protector according to claim 3,
wherein the inner case has an extending wall that extends from the bottom wall between the pair of side walls, and whose leading end portion in an extending direction is capable of coming into contact with the cover portion.

5. The protector according to claim 3,
wherein the cover portion has a reinforcing rib that protrudes toward the groove portion, and
the reinforcing rib is configured to be disposed between a plurality of electric wires contained in the wire harness housed in the groove portion.

6. The protector according to claim 2,
wherein a depth of the groove portion is greater than an outer diameter of an electric wire of the wire harness.

7. The protector according to claim 1,
wherein the pair of outer wall portions respectively have supporting portions configured to support the inner case.
